(19) United States
(12) Patent Application Publication
(10) Pub. No.: US 2025/0012591 A1
(43) Pub. Date: Jan. 9, 2025

(54) NAVIGATION METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Jingbo FAN, Shenzhen (CN); Qian CHEN, Shenzhen (CN); Lingfang PANG, Shenzhen (CN)

(21) Appl. No.: 18/888,269

(22) Filed: Sep. 18, 2024

Related U.S. Application Data
(63) Continuation of application No. PCT/CN2023/082050, filed on Mar. 17, 2023.

(30) Foreign Application Priority Data
May 19, 2022 (CN) 202210547448.X

(51) Int. Cl. G01C 21/36; H04W 4/029

(52) U.S. Cl. CPC G01C 21/365; H04W 4/029

(57) ABSTRACT

A navigation method is provided, including: displaying a navigation interface, where the navigation interface is configured for navigating a target vehicle; displaying, on the navigation interface, a navigation map and a virtual vehicle that moves in the navigation map as the target vehicle travels; and displaying, when navigating through the curve in the navigation map, that both the navigation map and a vehicle head direction of the virtual vehicle dynamically deviate according to a curving degree of the curve, where a deviation degree of the dynamic deviation changes along with a change of a curving degree of a moved position of the virtual vehicle in the curve.

### CROSS-REFERENCES TO RELATED APPLICATIONS

This application is a continuation application of PCT Patent Application No. PCT/CN2023/082050, filed on Mar. 17, 2023, which claims priority to Chinese Patent Application No. 202210547448.X, entitled “NAVIGATION METHOD AND APPARATUS, COMPUTER DEVICE, STORAGE MEDIUM, AND COMPUTER PROGRAM PRODUCT” and filed with the China National Intellectual Property Administration on May 19, 2022, the entire contents of both of which are incorporated herein by reference.

### FIELD OF THE TECHNOLOGY

The present disclosure relates to the field of computer technologies, and in particular, to a navigation method and apparatus, a computer device, a storage medium, and a computer program product.

### BACKGROUND OF THE DISCLOSURE

With the development of computer technologies and positioning technologies, electronic map navigation that serves vehicle driving has emerged. A navigation perspective of a navigation picture is usually head up (that is, a vehicle head is kept facing up/forward while view of the navigation picture changes accordingly). In a navigation picture that the navigation perspective is the head up, a direct top of a navigation map always changes along with a traveling direction, and the vehicle head is kept facing straight ahead, so that traveling of the vehicle can be efficiently and conveniently guided through left and right directions.

In such a navigation picture, when the vehicle travels in a curve, less content about the curve is displayed in the navigation picture, and prediction information for a driver on a road ahead is reduced, resulting in a poor navigation effect for the vehicle.

### SUMMARY

A navigation method is provided, including: displaying a navigation interface, where the navigation interface is configured for navigating a target vehicle; displaying, on the navigation interface, a navigation map and a virtual vehicle that moves in the navigation map as the target vehicle travels, where the navigation map includes a curve; and displaying, when the virtual vehicle is displayed in the curve (e.g., when navigating through the curve), that both the navigation map and a vehicle head direction of the virtual vehicle dynamically deviate according to a curving degree of the curve, where a deviation degree of the dynamic deviation changes along with a change of a curving degree of a moved position of the virtual vehicle in the curve.

A navigation apparatus is provided, including: a first display module, configured to: display a navigation interface, where the navigation interface is configured for navigating a target vehicle; and display, on the navigation interface, a navigation map and a virtual vehicle that moves in the navigation map as the target vehicle travels, where the navigation map includes a curve; and a second display module, configured to display, when navigating through the curve, that both the navigation map and a vehicle head direction of the virtual vehicle dynamically deviate according to a curving degree of the curve, where a deviation degree of the dynamic deviation changes along with a change of a curving degree of a moved position of the virtual vehicle in the curve.

A computer device is provided, including a memory and at least one processor, where the memory stores computer-readable instructions, and when executing the computer-readable instructions, the at least one processor performs the following operations: displaying a navigation interface, where the navigation interface is configured for navigating a target vehicle; displaying, on the navigation interface, a navigation map and a virtual vehicle that moves in the navigation map as the target vehicle travels, where the navigation map includes a curve; and displaying, when navigating through the curve, that both the navigation map and a vehicle head direction of the virtual vehicle dynamically deviate according to a curving degree of the curve, where a deviation degree of the dynamic deviation changes along with a change of a curving degree of a moved position of the virtual vehicle in the curve.

A non-transitory computer-readable storage medium is provided, having computer-readable instructions stored therein, when the computer-readable instructions being executed by at least one processor, the following operations being performed: displaying a navigation interface, where the navigation interface is configured for navigating a target vehicle; displaying, on the navigation interface, a navigation map and a virtual vehicle that moves in the navigation map as the target vehicle travels, where the navigation map includes a curve; and displaying, when navigating through the curve, that both the navigation map and a vehicle head direction of the virtual vehicle dynamically deviate according to a curving degree of the curve, where a deviation degree of the dynamic deviation changes along with a change of a curving degree of a moved position of the virtual vehicle in the curve.

### BRIEF DESCRIPTION OF THE DRAWINGS

The accompanying drawings, which are incorporated herein and constitute a part of the specification, illustrate embodiments consistent with the present disclosure and are used to explain the principles of the present disclosure together with the specification. Apparently, the accompanying drawings in the following descriptions are merely some embodiments of the present disclosure, and a person of ordinary skill in the art may further obtain other accompanying drawings according to the accompanying drawings without creative efforts.

FIG. 1 is a diagram of an application environment of a navigation method according to an embodiment.

FIG. 2 is a schematic diagram of a vehicle symbol always keeping head straight up.

FIG. 3 is a schematic diagram of a corresponding navigation interface when a target vehicle passes through a curve according to an embodiment.

FIG. 4 is a schematic flowchart of a navigation method according to an embodiment.

FIG. 5 is a schematic diagram of deviation of a vehicle head angle according to an embodiment.

FIG. 6 is a schematic diagram of a deviation angle of a virtual vehicle in a curve according to an embodiment.

FIG. 7 is a schematic diagram of a dynamic deviation angle of a virtual vehicle at each moment according to an embodiment.

FIG. 8 is a sequence diagram of calculating a dynamic deviation angle according to an embodiment.

FIG. 9 is a schematic diagram of an interface of a vehicle head angle evenly rotating in an opposite direction of a curve before entering the curve according to an embodiment.

FIG. 10 is a schematic diagram of an interface of keeping head up perspective.

FIG. 11 is a schematic diagram of an interface of a vehicle head angle in a curve dynamically changing along with a road curvature according to an embodiment.

FIG. 12 is a structural block diagram of a navigation apparatus according to an embodiment.

FIG. 13 is a diagram of an internal structure of a computer device according to an embodiment.

### DESCRIPTION OF EMBODIMENTS

To make the objectives, the technical solutions, and the advantages of the present disclosure clearer, the following describes the present disclosure in further detail with reference to the accompanying drawings and the embodiments. The embodiments described herein are merely used for explaining the present disclosure but are not intended to limit the present disclosure.

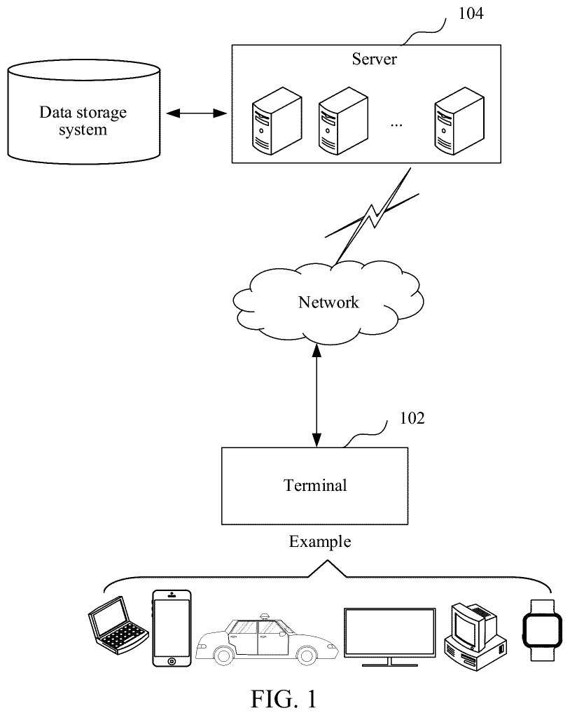

A navigation method provided in the embodiments of the present disclosure may be applied to an application environment shown in FIG. 1. A terminal 102 communicates with a server 104 by using a network. A data storage system may store data that the server 104 needs to process. The data storage system may be integrated on the server 104, or may be placed on a cloud or another server. In an embodiment, the server 104 provides a navigation service for the terminal. In a process of navigating a target vehicle, the terminal 102 displays a navigation interface, where the navigation interface is configured for navigating the target vehicle. A navigation map and a virtual vehicle that moves in the navigation map as the target vehicle travels are displayed on the navigation interface, where the navigation map includes a curve. When navigating through the curve, that both the navigation map and a vehicle head direction of the virtual vehicle dynamically deviate according to a curving degree of the curve is displayed, where a deviation degree of the dynamic deviation changes along with a change of a curving degree of a moved position of the virtual vehicle in the curve.

In an embodiment, an electronic map client may be run on the terminal 102, where the electronic map client may support vehicle navigation. When a driver drives the target vehicle, the driver may use the terminal 102 to start the electronic map client to navigate the target vehicle. In a navigation process, the server 104 communicates with the terminal 102 by using a network, to obtain positioning information of the target vehicle and road information of a traveling road, and calculate deviation angles at which the navigation map and the vehicle head direction of the virtual vehicle in the navigation interface deviate along with a dynamic change of the curve, so that the terminal 102 implements the vehicle navigation method provided in the embodiments of the present disclosure. The terminal 102 may be but not limited to any desktop computer, a notebook computer, a smartphone, a tablet computer, an Internet of Things device, and a portable wearable device, where the Internet of Things device may be a smart speaker, a smart television, a smart air conditioner, a smart voice interaction device, a smart in-vehicle device, or the like. The portable wearable device may be a smart watch, a smart bracelet, a headset device, or the like. The server 104 may be implemented by using an independent server or a server cluster including a plurality of servers. The embodiments of the present disclosure may be applied to various scenarios, including but not limited to, a cloud technology, artificial intelligence, intelligent transportation, assisted driving, and the like.

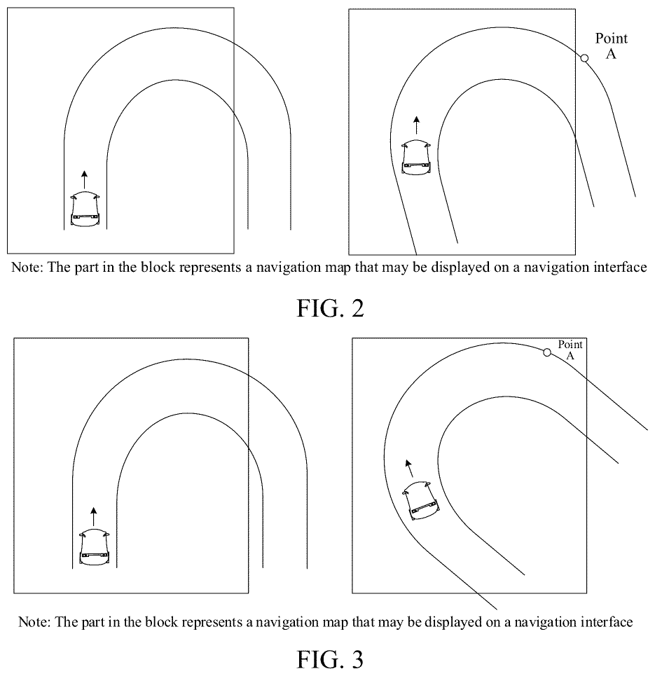

Generally, for electronic map navigation that serves a vehicle, a navigation perspective of a navigation picture usually includes head up and north up. In a navigation picture in which the navigation perspective is the head up, a direct top of the navigation map always changes along with a traveling direction, and a vehicle head is kept facing upward. As shown in FIG. 2, whether traveling in a straight line or passing through a curve, a virtual vehicle in the navigation map is always presented in a head up direction, and the navigation map changes along with the vehicle head direction of the virtual vehicle. In this way, the vehicle can be efficiently and effectively guided through left and right directions. In a navigation picture in which the navigation perspective is the north up, route navigation needs to be performed through a direction or adjusting an orientation of a mobile phone to a due north direction. Compared with the head up navigation perspective, this navigation manner has a poor effect, but it is convenient to obtain an orientation of the vehicle.

In a head up navigation mode, when the target vehicle travels in the curve, since the virtual vehicle always keeps head up, as shown in FIG. 2, the virtual vehicle also keeps head up in the curve, so that a visual distance in the curve is short, and beyond-line-of-sight information (information that cannot be displayed on the navigation interface originally) in the front cannot be displayed on the navigation interface, so that prediction of the driver on a road ahead is reduced, resulting in a poor navigation effect for the vehicle and a low sense of driving safety when passing through the curve.

According to the navigation method provided in the embodiments of the present disclosure, in a process of navigating a target vehicle, a navigation interface configured for navigating the target vehicle is displayed, where the navigation interface includes a virtual vehicle that corresponds to the target vehicle and moves as the target vehicle travels on a road. When the virtual vehicle moves into a curve on a navigation route as the target vehicle travels, the navigation map and the vehicle head direction of the virtual vehicle no longer keep the head up, but dynamically deviate according to a change of a curving degree of a moved position of the virtual vehicle until the virtual vehicle moves out of the curve. In this way, when the target vehicle travels in the curve, more road environments in the front about the curve are displayed on the navigation interface, increasing prediction and guidance of a driver on a road ahead, thereby improving a navigation effect for the vehicle.

FIG. 3 is a schematic diagram of a corresponding navigation interface when a target vehicle passes through a curve according to an embodiment. Compared with that the virtual vehicle always keeps the head up in the navigation interface in FIG. 2, referring to FIG. 3, when the target vehicle passes through the curve, more road environments in the front about the curve can be displayed on the navigation interface, and beyond-line-of-sight information that cannot be displayed originally is presented on the navigation map, such as a point A in the figure, so that prediction and guidance of the driver on the road ahead may be increased, thereby improving a navigation effect for the vehicle.

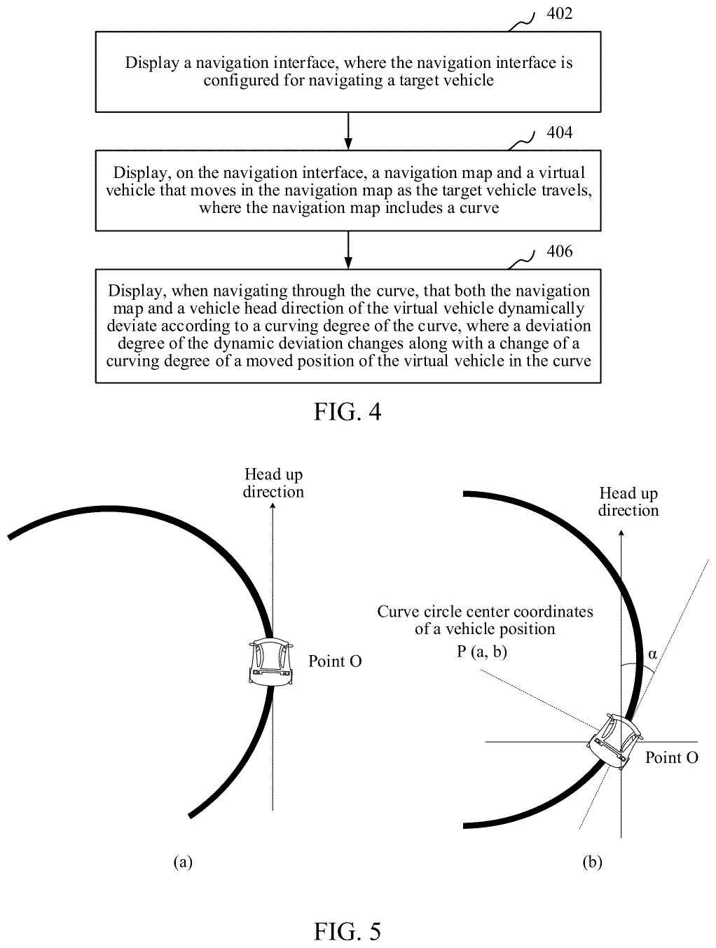

In an embodiment, as shown in FIG. 4, a navigation method is provided. An example in which the method is applied to the terminal 102 in FIG. 1 is used for description, and the method includes the following operations:

Operation 402: Display a navigation interface, where the navigation interface is configured for navigating a target vehicle.

Operation 404: Display, on the navigation interface, a navigation map and a virtual vehicle that moves in the navigation map as the target vehicle travels, where the navigation map includes a curve.

The navigation interface is an interface displaying an electronic navigation map. An electronic map related to a road in the navigation interface is referred to as a navigation map. In a process of navigating the target vehicle, a navigation route is displayed on the navigation interface, where the navigation route includes the curve and further includes the virtual vehicle corresponding to the target vehicle. Certainly, the target vehicle may alternatively be indicated through another mark such as an arrow or a circle in the navigation interface. The target vehicle is a vehicle traveling on an actual road during vehicle navigation.

In an actual application, the navigation interface may have a plurality of navigation perspectives, including head up, north up, and the like. The head up refers to that a direct top of the navigation map changes along with a traveling direction of the target vehicle. For example, when the target vehicle travels toward the west, the direct top of the navigation map faces the west; and when the target vehicle travels toward the east, the direct top of the navigation map faces the east. In this way, when referring to the navigation map, the driver only needs to determine, through left and right directions, a direction to turn, which helps the driver to control the traveling direction of the vehicle. The north up refers to that an orientation of the navigation map always keeps the direct top as the north and does not change the direction. The orientation of the navigation map does not change as the target vehicle travels. The driver mainly determines a direction to turn according to a direction or adjusting a navigation device to a due north direction. This is suitable for a user with a good sense of direction, which allows the user to know a direction in which the vehicle travels at any time. The embodiments of the present disclosure are mainly applied to a navigation mode in which the navigation perspective is the head up.

In an actual application, a road condition displayed on the navigation interface may be three-dimensional, and the navigation interface is a navigation interface of a three-dimensional electronic navigation map. Certainly, a road environment displayed on the navigation interface may alternatively be two-dimensional, and the navigation interface is a navigation interface of a two-dimensional electronic navigation map. The driver or the user may perform selection or switching according to an actual requirement.

Specifically, when vehicle navigation is required, the user may start, through a terminal, an application program supporting the vehicle navigation. The navigation interface configured for navigating the target vehicle is displayed in a navigation application, and the virtual vehicle displayed on the navigation interface moves in the navigation map as the target vehicle travels.

Operation 406: Display, when navigating through the curve, that both the navigation map and a vehicle head direction of the virtual vehicle dynamically deviate according to a curving degree of the curve, where a deviation degree of the dynamic deviation changes along with a change of a curving degree of a moved position of the virtual vehicle in the curve.

The curve is a segment of path whose curvature is non-zero on a road, and the curve may be an intersection, a fork, a loop road, or the like at which turning or turning around is required. In addition, the navigation route configured for navigating the target vehicle may further include a straight road. In a process of moving in the curve, the moved position of the virtual vehicle is a position point in the curve. The curving degree of the moved position may be represented by a curve curvature at the corresponding position point. A larger curvature indicates a smaller curvature radius, a higher curving degree indicates a smaller curvature, and a larger curvature radius indicates a lower curving degree. That the navigation map and the vehicle head direction of the virtual vehicle dynamically deviate according to a curving degree of a moved position of the virtual vehicle is specifically manifested as that a deviation angle of the moved position of the virtual vehicle is related to the curvature of the moved position. The deviation angle dynamically changes, and the deviation angle dynamically changes along with a change of the curvature at the moved position of the virtual vehicle.

A deviation angle corresponding to each position point in the curve of the virtual vehicle may be determined according to the position point and curvature circle center coordinates corresponding to the position point. The curvature circle center coordinates are coordinates of a center of circle of a curvature circle corresponding to a position point on the curve. Each position point in the curve corresponds to different curvature circle center coordinates. The curvature circle center coordinates are a point on a normal line of the curve at a position point O (x, y). A distance between the point and the position point O (x, y) is equal to a curvature radius R at the point, where the curvature radius R is a reciprocal of a curvature k, and the curvature k may be determined according to a first-order derivative and a second-order derivative of the curve at the position point O (x, y). Therefore, the deviation angle corresponding to each position point in the curve is related to the curvature.

The vehicle head direction of the virtual vehicle is a direction indicated by the vehicle head of the virtual vehicle. In the navigation interface in which the navigation perspective is the head up, the vehicle head direction of the virtual vehicle always keeps the head up. However, in this embodiment, when the target vehicle travels in a curve of a road, the navigation map and the vehicle head direction of the virtual vehicle that are displayed on the navigation interface no longer keep the vehicle head direction unchanged, but dynamically deviate from the original head up direction according to the curving degree of the moved position of the virtual vehicle until the virtual vehicle moves out of the curve. That is, when navigating through the curve of the navigation map, it is displayed that the navigation map deviates according to the curving degree of the moved position of the virtual vehicle, and that the vehicle head direction of the virtual vehicle deviates according to the curving degree of the moved position of the virtual vehicle. In a process of navigating the target vehicle, a vehicle head direction of the target vehicle in an actual traveling process is controlled by the driver or an autonomous driving system, and is not directly related to the dynamic deviation of the vehicle head direction of the virtual vehicle.

In the foregoing navigation method, in a process of navigating a target vehicle, a navigation interface configured for navigating the target vehicle is displayed, where the navigation interface includes a virtual vehicle that represents the target vehicle and moves as the target vehicle travels on a road. When the virtual vehicle moves into a curve on a navigation route as the target vehicle travels, a navigation map and a vehicle head direction of the virtual vehicle no longer keep at the same direction, such as keep head up, but dynamically deviate according to a curving degree of a moved position of the virtual vehicle until the virtual vehicle moves out of the curve. In this way, when the target vehicle travels in the curve, more road environments in the front about the curve are displayed on the navigation interface, increasing prediction and guidance of a driver on a road ahead, thereby improving a navigation effect for the vehicle.

In an embodiment, the navigation method may further include: displaying, in a process that both the navigation map and the vehicle head direction of the virtual vehicle dynamically deviate according to the curving degree of the curve, beyond-line-of-sight content about a front of the curve on the navigation interface.

Specifically, that both the navigation map and the vehicle head direction of the virtual vehicle dynamically deviate according to the curving degree of the curve is that the vehicle head of the virtual vehicle dynamically deviates according to the curving degree of the curve, and when the vehicle head of the virtual vehicle dynamically deviates according to the curving degree of the curve, the navigation map correspondingly deviates toward a deviation direction of the vehicle head direction. In this way, when the navigation map correspondingly deviates toward the deviation direction of the vehicle head direction, the beyond-line-of-sight content about the front of the curve may be moved into the navigation map.

The beyond-line-of-sight content about the front of the curve is information about the front of the curve that cannot be displayed on the navigation interface originally and beyond a line of sight of the driver. By displaying such beyond-line-of-sight information in advance on the navigation interface due to the deviation of the vehicle head angle, prediction of the driver on the road can be assisted. The beyond-line-of-sight information about the front of the curve may include a direction, a shape, a quantity of lanes, and the like of the curve, and may further include other road environments near the curve, such as green plant, a building, and an identifier. It can be learned from comparison between FIG. 2 and FIG. 3 that, in FIG. 2, less information about the road condition in the front of the curve is displayed, and in FIG. 3, more information about the road condition in the front of the curve is displayed (the point A that is not originally displayed is displayed on the navigation interface), and more beyond-line-of-sight information is displayed on the navigation interface.

In an embodiment, the navigation perspective of the navigation interface is the head up. The dynamic deviation is that an angle α t which the vehicle head direction of the virtual vehicle deviates from the head up direction changes along with a change of the curving degree of the moved position of the virtual vehicle in the curve, and the navigation map deviates along with deviation of the vehicle head direction. In other words, when navigating through the curve of the navigation map, it is displayed that both the navigation map and the vehicle head direction of the virtual vehicle dynamically deviate from the head up direction according to the curving degree of the moved position of the virtual vehicle.

The embodiments of the present disclosure are mainly applied to the navigation interface in which the navigation perspective is the head up, and the head up direction is a direction in which the direct top of the navigation interface is located. A purpose of dynamically deviating from the head up direction is to display more beyond-line-of-sight content on the navigation interface. A direction in which the dynamic deviation deviates from the head up direction is a direction opposite to a curving direction of the curve. To display more beyond-line-of-sight content about the curve, when the curvature of the moved position of the virtual vehicle indicates that the curve curves to the right, the terminal displays that both the vehicle head direction of the virtual vehicle and the navigation map dynamically deviate to the left, to deviate from the head up direction; and when the curvature of the moved position of the virtual vehicle indicates that the curve curves to the left, the terminal displays that both the vehicle head direction of the virtual vehicle and the navigation map dynamically deviate to the right, to deviate from the head up direction.

FIG. 5 is a schematic diagram of deviation of a vehicle head angle according to an embodiment. Referring to a part (a) of FIG. 5, when passing through the position point O of the curve, the virtual vehicle always keeps the head up and does not deviate from the direct top, and the navigation map is displayed in cooperation with the vehicle head direction of the virtual vehicle. Referring to a part (b) of FIG. 5, the method provided in this embodiment of the present disclosure is used. Similarly, when passing through the position point O of the curve, the vehicle head direction of the virtual head deviates to the right by an angle α, at the same time, the navigation map also rotates correspondingly. In this way, more beyond-line-of-sight content about the front of the curve can be displayed in a left region of the navigation map.

In an embodiment, the navigation perspective of the navigation interface is the head up; and the navigation method further includes: displaying that the virtual vehicle moves into the curve from a curve starting point at an initial angle deviating from the head up direction. Specifically, in a process that the virtual vehicle moves in the navigation map, in response to that the moved position of the virtual vehicle is the curve starting point, that the virtual vehicle moves into the curve at the initial angle deviating from the head up direction is displayed on the navigation interface.

In this embodiment of the present disclosure, the navigation map is known data. Road data of the navigation map includes route curvature data, where the route curvature data includes coordinates of each position point on the road, and a curvature, a curvature radius, and curvature circle center coordinates that correspond to each position point. In a traveling process of the target vehicle, the terminal correspondingly moves the virtual vehicle in the navigation map according to a real-time position of the target vehicle. A computer device may determine coordinates of a curve starting point on a navigation route ahead. When positioning coordinates of the virtual vehicle are the coordinates, it indicates that the virtual vehicle moves into the curve starting point. A road curvature of a straight road is zero. When the curvature of the moved position of the virtual vehicle changes from zero to non-zero, it indicates that the virtual vehicle moves into the curve. When moving into the curve, there is an initial deviation angle, and the terminal displays that the virtual vehicle moves into the curve at the initial angle.

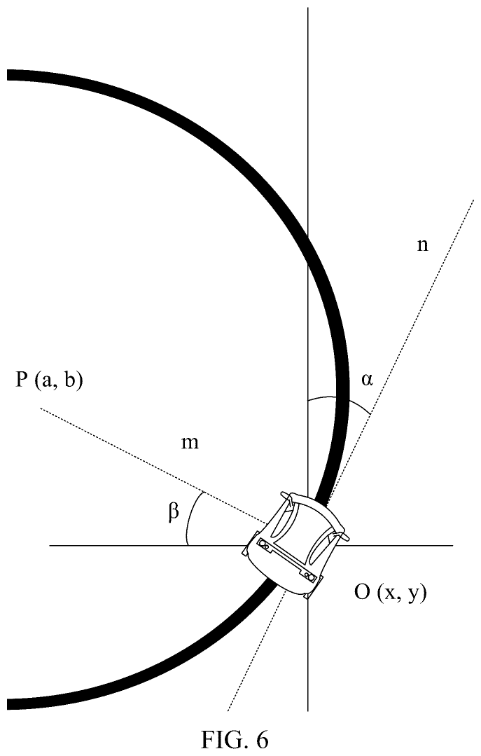

FIG. 6 is a schematic diagram of a process of inferring an angle α t which a virtual vehicle deviates from a head up direction in a curve according to an embodiment. Referring to FIG. 6, assuming that a position point into which the virtual vehicle moves in the curve is O (x, y), that is, the vehicle coordinates are O (x, y), curvature circle center coordinates P (a, b) of a curvature circle corresponding to O (x, y) are obtained according to the route curvature data. Each position point in the curve corresponds to different curvature circle center coordinates. The curvature circle center coordinates are a point on a normal line of the curve at the position point O (x, y). A distance between the point and the position point O (x, y) is equal to a curvature radius at the point, where the curvature radius is a reciprocal of a curvature k, and the curvature k may be determined according to a first-order derivative and a second-order derivative of the curve at the position point O (x, y). The curvature radius of the curvature circle is R (a distance between the point P and the point O), and (x−a)²+ (y−b)²=R². The normal line of the position point of the vehicle is m, and the vehicle head direction of the virtual vehicle is a direction in which a tangent line of the position point of the vehicle on the curvature circle is located, where the tangent line is n, a slop of the tangent line n is K, the deviation angle of the vehicle head direction is α, α=β, and 1/K=(b−y)/(a−x)=tan a, so that it is inferred that α=arc tan((b−y)/(a−x)).

The deviation angle α is related to the coordinates O (x, y) of the position point to which the virtual vehicle moves and the curvature circle center coordinates P (a, b) of the curvature circle, and the coordinates O (x, y) of the position point to which the virtual vehicle moves and the curvature circle center coordinates P (a, b) of the curvature circle are related to a curvature of the position point O (x, y) to which the virtual vehicle moves. In other words, the deviation angle α dynamically changes along with the curvature of the moved position of the virtual vehicle.

Further, displaying, in a process that the virtual vehicle moves in the curve, on the navigation interface, that the navigation map and the vehicle head direction of the virtual vehicle dynamically deviate according to the curving degree of the moved position of the virtual vehicle includes: displaying, after the virtual vehicle moves into the curve from the curve starting point at the initial angle deviating from the head up direction, that the navigation map and vehicle head direction of the virtual vehicle dynamically deviate from the head up direction according to the curving degree of the moved position of the virtual vehicle until the virtual vehicle moves out of the curve.

According to the foregoing inference, after the virtual vehicle moves into the curve as the target vehicle travels, the vehicle head angle of the virtual vehicle may continue to dynamically deviate from the initial angle, in other words, the vehicle head angle of the virtual vehicle deviates based on the deviation angle of each position point according to the curving degree of the moved position of the virtual vehicle, to pass through the curve in a manner of dynamically deviating from the head up direction.

In an embodiment, the curve is located on the navigation route of the target vehicle, and the navigation method may further include: determining a position point at which a curvature on the navigation route of the target vehicle changes from zero to non-zero as the curve starting point of the curve; obtaining curvature circle center coordinates corresponding to the curve starting point; and calculating, according to the curve starting point and the curvature circle center coordinates, a deviation angle between a tangent line at the curve starting point and the head up direction as the initial angle when the virtual vehicle moves into the curve.

The navigation route is a route calculated according to a set navigation starting point and a set navigation destination, that is, a series of roads starting from the navigation starting point to the final navigation destination. In the embodiments of the present disclosure, the navigation route includes a curve. The curve starting point is a position point at which the curvature changes from zero to non-zero in position points on the navigation route. The navigation route may include a lane suggested for traveling on each road that needs to pass through, or lanes are not distinguished. Certainly, lanes may be distinguished on some roads, and may not be distinguished on some other roads.

The terminal may obtain coordinates of each position point on the navigation route and a curvature of each position point, to use a position point at which the curvature changes from continuous zero to non-zero as the curve starting point, obtain the curvature circle center coordinates corresponding to the curve starting point, and calculate, according to the curve starting point and the curvature circle center coordinates, the deviation angle between the tangent line at the curve starting point and the head up direction as the initial angle when the virtual vehicle moves into the curve. The terminal may use a position point on the navigation route at which the curvature changes from non-zero to continuous zero as a curve ending point, that is, a position point at which the virtual vehicle moves out of the curve.

In an embodiment, the navigation method may further include: estimating, starting from a moment at which the virtual vehicle moves into the curve, a trajectory offset of the virtual vehicle at a next moment relative to a current moment according to a curvature radius of a curve position point and a traveling speed of the virtual vehicle at the current moment; estimating a curve position point of the virtual vehicle at the next moment according to the curve position point of the virtual vehicle at the current moment and the trajectory offset; obtaining curvature circle center coordinates corresponding to the estimated curve position point of the virtual vehicle at the next moment; and determining a deviation angle of the curve position point at the next moment according to the curve position point at the next moment and the curvature circle center coordinates corresponding to the curve position point at the next moment.

The current moment and the next moment are two adjacent moments when the virtual vehicle moves into the curve, for example, a moment t and a moment t+1. As inferred in the above, the deviation angle of each position point of the virtual vehicle in the curve is related to coordinates of the vehicle position and curvature circle center coordinates corresponding to the vehicle position. The terminal predicts a position to which the virtual vehicle moves at the moment t+1 according to data at the moment t, and then calculates, according to coordinates corresponding to the position to which the virtual vehicle moves at the moment t+1 and curvature circle center coordinates corresponding to the position, a deviation angle corresponding to the position to which the virtual vehicle moves at the moment t+1.

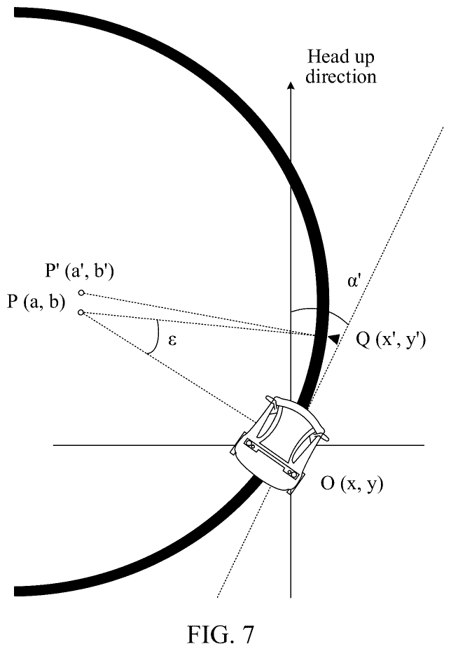

FIG. 7 is a schematic diagram of calculating a dynamic deviation angle of a virtual vehicle at each moment according to an embodiment. Referring to FIG. 7, a process of calculating a deviation angle of the vehicle head direction of the virtual vehicle in real time may be inferred. A traveling speed of the target vehicle is denoted as v, an interval time during which the vehicle travels from the moment t to the moment t+1 in the curve is Δt, a traveling arc length is L, a trajectory offset of the vehicle is ε°, and a curvature radius corresponding to a position at which the vehicle is located at the moment t is R. A smaller Δt indicates that a traveling trajectory of the vehicle in the curve is closer to an arc. In this case, L=v*Δt; Δt=2πR*ε°/(v*360°); and ε°=180° *v*Δt/πR. Assuming that the interval time between the moment t and the moment t+1 is 1 second, that is, Δt=1, then &°=180° *v/πR. That is, the trajectory offset &° of the vehicle is only related to the traveling speed of the vehicle, and a position Q (x′, y′) to which the virtual vehicle moves at the moment t+1 may be estimated according to the trajectory offset ε° of the vehicle.

After the position Q (x′, y′) to which the virtual vehicle moves at the moment t+1 is estimated, curvature circle center coordinates P′ (a′, b′) of a curvature circle corresponding to the position Q (x′, y′) are obtained. In this way, the deviation angle of the vehicle head direction of the virtual vehicle at the moment t+1 is α′=arc tan ((b′−y′)/(a′−x′)).

In an embodiment, the navigation method may further include: obtaining a real-time position of the target vehicle; displaying, on the navigation interface, a navigation map matching the real-time position; and obtaining route curvature data of a navigation route in the navigation map, where the route curvature data includes a curvature, a curvature radius, and curvature circle center coordinates that correspond to each position point on the navigation route in the navigation map.

In this embodiment, the navigation map displays a navigation map that matches the real-time position to which the target vehicle travels. The terminal may obtain a segment of route curvature data at the real-time position on the navigation route, where the route curvature data can reflect a form of the road and may include coordinates of each position point on the navigation route and data such as the curvature, the curvature radius, the curvature circle center coordinates that correspond to each position point. In this way, real-time positioning information of the target vehicle may be mapped to each position point on the navigation route, to determine the position point to which the virtual vehicle moves and the route curvature data corresponding to the position point, which may be used to calculate a deviation angle α t a next second.

In an embodiment, the obtaining a real-time position of the target vehicle includes: obtaining real-time data collected by a sensor arranged on the target vehicle, where the sensor includes at least one of a camera or a radar; and performing positioning calibration on the target vehicle based on the real-time data collected by the sensor to obtain the real-time position of the target vehicle.

The real-time data collected by the sensor arranged on the target vehicle may be sent to a server through an in-vehicle terminal, and the server performs positioning calibration on the target vehicle according to the collected real-time data to obtain the real-time position of the target vehicle. The server may alternatively deliver the collected real-time data to the terminal, and the terminal performs positioning calibration on the target vehicle to obtain the real-time position of the target vehicle.

The sensor arranged on the target vehicle may include a radar, a lidar, a camera, or the like. Real-time image data collected by the sensor may be configured for calibrating the real-time position of the target vehicle. A real-time position after calibration may be configured for determining a display position of the virtual vehicle in the navigation map.

In an embodiment, the obtaining route curvature data of a navigation route in the navigation map includes: obtaining a preset distance; and obtaining, based on the real-time position of the target vehicle, route curvature data located at the preset distance ahead of the real-time position on the navigation route in the navigation map.

The preset distance may be, for example, 2 kilometers. Specifically, after determining the real-time position of the target vehicle, the server may obtain route curvature data in a range of 2 kilometers in the front of the real-time position in the navigation map, and calculate, based on the route curvature data, a deviation angle corresponding to each position point on the curve to which the virtual vehicle moves in the range of 2 kilometers ahead. In an embodiment, the terminal determines whether there is a curve ahead according to the route curvature data in the range of 2 kilometers ahead. If there is a curve ahead, the terminal may determine a curve starting point according to curve curvature data, and when the target vehicle travels to the curve starting point, the terminal may start to calculate in real time the deviation angle of the vehicle head direction every second in the curve.

For example, when the virtual vehicle moves to the curve starting point, the terminal may start to estimate, according to a curvature radius when the virtual vehicle moves into the curve starting point and the traveling speed of the target vehicle, the deviation angle α t which the vehicle head direction of the virtual vehicle dynamically deviates along with the curvature of the position point every second in the curve in the range of 2 kilometers ahead. For example, if coordinates when the virtual vehicle moves into the curve starting point are M1, in this case, a vehicle position P2 at the next second may be estimated according to a curvature radius and the traveling speed when the virtual vehicle moves into the curve starting point M1, and a deviation angle of the vehicle head direction of the virtual vehicle at the next second may be calculated according to route curvature data corresponding to P2. Similarly, if an actual position of the virtual vehicle at the next second is M2, in this case, a vehicle position P3 at a next but one second may be estimated according to a curvature radius corresponding to M2 and the traveling speed, and a deviation angle of the vehicle head direction of the virtual vehicle at the next but one second may be calculated according to route curvature data corresponding to P3, and so on until the virtual vehicle moves out of the curve. A frequency of counting the deviation angle of the vehicle head direction of the virtual vehicle is not limited in the embodiments of the present disclosure. For example, the terminal may alternatively update the deviation angle of the vehicle head direction of the virtual vehicle every 2 seconds.

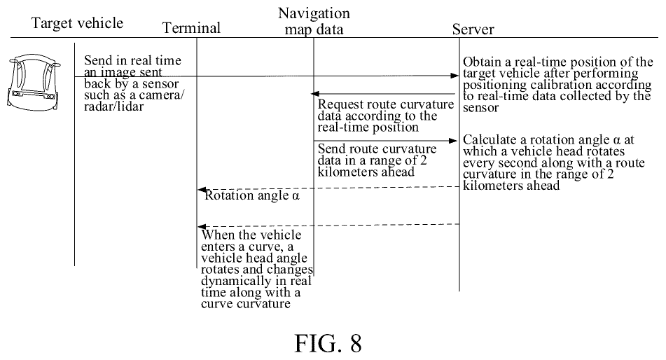

FIG. 8 is a sequence diagram of calculating a dynamic deviation angle according to an embodiment. Referring to FIG. 8, the in-vehicle terminal on the target vehicle may transmit in real time an image returned by a sensor such as a camera, a radar, or a lidar to the server. The server obtains the real-time position of the target vehicle after performing positioning calibration according to the real-time data collected by the sensor, and obtains the route curvature data of the navigation route in the range of 2 kilometers in the front of the real-time position from a map database according to the real-time position. The server then calculates, according to the data, the deviation angle of the vehicle head direction dynamically changing along with the route curvature data every second after the virtual vehicle moves into the curve. When the target vehicle moves into the curve, an electronic map navigation application program on the terminal displays, according to the deviation angle, that the vehicle head angle of the virtual vehicle dynamically changes in real time along with the route curvature.

In an embodiment, the navigation method may further include: between a moment at which the virtual vehicle moves to a position at a target distance from entering the curve and a moment at which the virtual vehicle enters the curve, displaying that both the navigation map and the vehicle head direction of the virtual vehicle deviate in an opposite direction of the curve at a plurality of times, where deviation degrees of the plurality of deviation increases in time sequence.

Generally, in the navigation interface in which the navigation perspective is the head up, when the vehicle travels on a straight road before entering the curve, the vehicle head direction of the virtual vehicle always keeps the head up and does not deviate from the direct top of the navigation map. This leads to severe rotation of the navigation map caused by a sharp increase in a curvature of the curve when the virtual vehicle enters the curve, causing the driver to feel dizzy and increasing the costs of reading the navigation map. In this embodiment, between the moment at which the virtual vehicle moves to the position at the target distance before entering the curve and the moment at which the virtual vehicle enters the curve, the vehicle head angle deviates evenly to an opposite direction along with a direction of the curve until the virtual vehicle moves into the curve, so that the navigation map rotates gradually, which can overcome the foregoing problem.

The target distance may be a set distance. When moving to the position at the target distance from the curve, the virtual vehicle starts to deviate in the opposite direction of the curve in advance. A purpose is to reduce a change amplitude of the deviation angle of the navigation map before and after the virtual vehicle moves into the curve, thereby overcoming a problem of severe rotation of the navigation map when the virtual vehicle enters the curve.

In an embodiment, the target distance is a distance that causes a deviation angle change amount after the virtual vehicle moves into the curve and when the virtual vehicle moves into the curve to be consistent and coherent with a deviation angle change amount when the virtual vehicle moves into the curve and before the virtual vehicle moves into the curve. For example, a moment when the virtual vehicle moves into the curve is denoted as t, and a moment after the virtual vehicle moves into the curve is denoted as t+1. In this case, a deviation angle change amount of the virtual vehicle at the moment t and a moment t−1 shall be coherent with a deviation angle change amount of the virtual vehicle at the moment t+1 and the moment t. For example, if the deviation angle change amounts are the same, it indicates that the deviation angle changes at a constant speed; and in another example, if the deviation angle change amounts increase gradually, it indicates that the deviation angle changes at a uniform acceleration.

Between the moment at which the virtual vehicle moves to the position at the target distance from entering the curve and the moment at which the virtual vehicle enters the curve, both the navigation map and the vehicle head direction of the virtual vehicle deviate in the opposite direction of the curve at a plurality of moments.

For example, the moment at which the virtual vehicle moves to the position at the target distance from entering the curve is denoted as t−n, and the moment at which the virtual vehicle enters the curve is denoted as t. When the virtual vehicle moves to the position at the target distance from the curve at the moment t−n, the navigation map and the vehicle head direction of the virtual vehicle start to deviate in the opposite direction of the curve. In a process that the virtual vehicle continues to move toward the curve, from the moment t-n to the moment t, the navigation map and the vehicle head direction of the virtual vehicle continues to deviate, and a deviation degree of the vehicle head direction gradually increases each time in time sequence. For example, at the moment t−n, a deviation degree of the vehicle head direction is 5°, at a moment t−n+5, a deviation degree of the vehicle head direction is 10°, and at a moment t−n+10, a deviation degree of the vehicle head direction is 15°. Similarly, since a deviation degree of the navigation map is consistent with the deviation degree of the vehicle head direction, the deviation degree of the navigation map also gradually increases each time in the time sequence.

That the deviation degree of the virtual vehicle after moving into the curve is consistent and coherent with the deviation degree of the virtual vehicle before moving into the curve may be reflected by the deviation angle change amount. That is, the deviation angle change amount after the virtual vehicle moves into the curve and when the virtual vehicle moves into the curve is consistent and coherent with the deviation angle change amount when the virtual vehicle moves into the curve and before the virtual vehicle moves into the curve. For example, assuming that a moment when the virtual vehicle moves into the curve is a moment t, a moment before the virtual vehicle moves into the curve is a moment t−1, and a moment after the virtual vehicle moves into the curve is a moment t+1, a deviation angle change amount from the moment t−1 to the moment t and a deviation angle change amount from the moment t to the moment t+1 are even. The deviation angle is an angle α t which the vehicle head direction of the virtual vehicle deviates from the head up direction at a specific moment, which may be denoted as a. That the deviation angle change amount from the moment t−1 to the moment t and the deviation angle change amount from the moment t to the moment t+1 are even is specifically reflected in that: the deviation angle change amount from the moment t−1 to the moment t may be the same as the deviation angle change amount from the moment t to the moment t+1, for example, both are 2°; and the deviation angle change amount from the moment t−1 to the moment t and the deviation angle change amount from the moment t to the moment t+1 may be evenly increased, for example: the deviation angle change amount from the moment t to the moment t+1 is 2°, and a deviation angle change amount from the moment t+1 to a moment t+2 is 2.5°. It may be determined that after the virtual vehicle moves into the curve, the deviation angle change amount evenly increases by 0.5°. Therefore, it may be determined that the deviation angle change amount from the moment t−1 to the moment t is 2°−0.5°=1.5°.

Further, the navigation method may further include: determining an initial angle when the virtual vehicle moves into the curve according to a curve starting point of the curve and curvature circle center coordinates corresponding to the curve starting point; and calculating the target distance according to a current traveling speed of the target vehicle and the initial angle.

In an embodiment, the terminal determines whether there is a curve ahead according to the route curvature data in the range of 2 kilometers ahead. If there is a curve, the terminal may determine the curve starting point according to the curve curvature data, calculate the initial angle when the virtual vehicle moves into the curve according to the route curvature data of the curve starting point, calculate a deviation angle change amount required for even deviation of the deviation angle from the target distance according to the initial angle α and the current traveling speed of the vehicle, and calculate to obtain the target distance according to the current traveling speed and the deviation angle change amount, and the initial angle.

Further, the calculating the target distance according to a current traveling speed of the target vehicle and the initial angle includes: estimating a trajectory offset after the virtual vehicle moves into the curve according to the current traveling speed of the target vehicle and a curvature radius corresponding to the curve starting point; estimating a vehicle position after the virtual vehicle moves into the curve according to the trajectory offset; calculating an estimated deviation angle corresponding to the vehicle position according to the estimated vehicle position and curvature circle center coordinates corresponding to the vehicle position; determining a deviation angle change amount of a vehicle head angle of the virtual vehicle according to the initial angle when the virtual vehicle moves into the curve and the estimated deviation angle after the virtual vehicle moves into the curve; and calculating the target distance according to the current traveling speed, the initial angle, and the deviation angle change amount.

To achieve even coherence between the vehicle head angle and a deviation speed of the vehicle head before and when the virtual vehicle enters the curve, assuming that the vehicle head angle starts to rotate at an even speed before s meters in front of the curve, a change amount of the vehicle head angle is v1, a traveling speed of the target vehicle is v2, and an initial angle when the virtual vehicle moves into the curve is α0. When the vehicle head angle deviates from 0° to α0 within s meters, v2/s=v1/α0; and v1=v2*α0/s. A value of v1 changes along with the traveling speed v2. Assuming that the deviation angle of the virtual vehicle after moving into the curve is α1, an angle deviation amount of the virtual vehicle in the curve is α1−α0, and when v1−α1−α0, the even coherence between the vehicle head angle and a deviation speed of the vehicle head before and when the virtual vehicle enters the curve can be achieved. Therefore, v2*α0/s=α1−α0, and s=v2*α0/(α1−α0).

For example, when the speed at which the virtual vehicle moves into the curve is v2=60 km/h, and the initial angle α0 at which the virtual vehicle moves into the curve is 30°, after the virtual vehicle moves into the curve, that is, after the virtual vehicle moves into a curve 1, the vehicle head angle α1 is 32°, then the change amount of the vehicle head angle is 2°, and a distance is s=v2*α0/(α1−α0)=255 meters. That is, at a distance of 255 meters before entering the curve, the vehicle head angle starts to deviate from the head up direction at a speed of 2° every second until the virtual vehicle moves into the curve at the initial angle of 30°, and the deviation angle α t the next second is 32°.

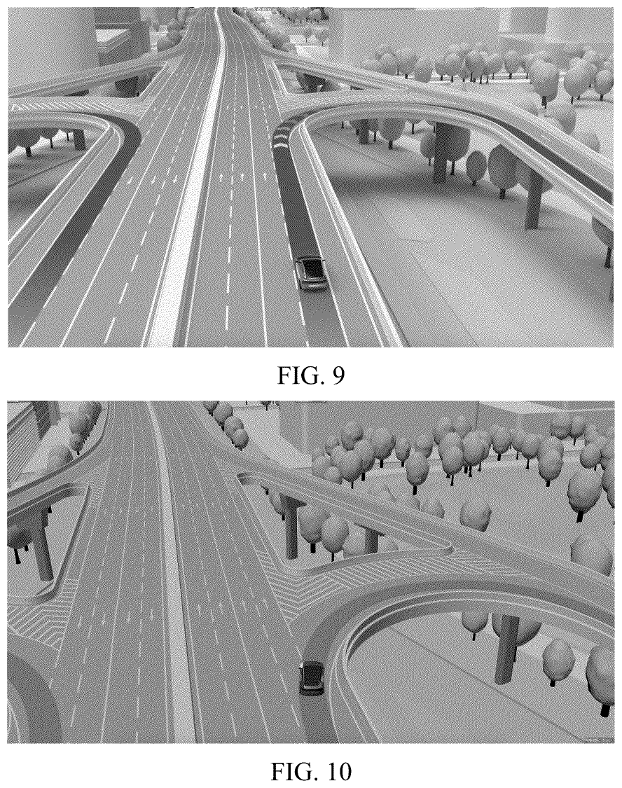

FIG. 9 is a schematic diagram of an interface of a vehicle head angle and a navigation map evenly rotating in an opposite direction of a curve before entering the curve until entering the curve according to an embodiment. Referring to FIG. 9, when preparing to enter the curve, since a direction of the curve faces the right, the vehicle head angle deviates slightly to the left.

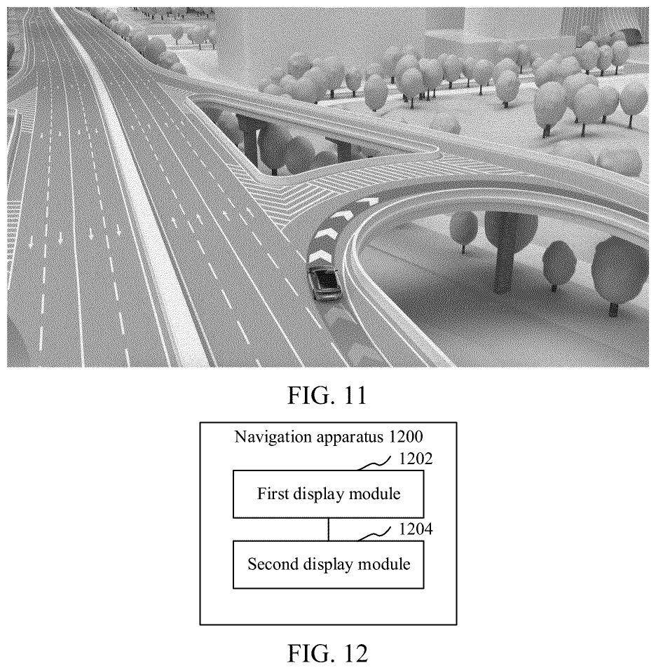

FIG. 10 is a schematic diagram of an interface of keeping a head up perspective in a curve. The view of the navigation map is displayed based on the vehicle head direction which is always kept at a direction facing forward/upward. FIG. 11 is a schematic diagram of an interface of a vehicle head angle in a curve dynamically changing along with a road curvature according to an embodiment. Both the vehicle head angle and the navigation map rotate to the left by an angle, so that (compared to the view shown in FIG. 10) more beyond-line-of-sight information is displayed on the right side.

In an embodiment, the navigation method may further include: displaying, on the navigation interface before the virtual vehicle moves into the curve and when a distance between the virtual vehicle and the curve is greater than the target distance, that the virtual vehicle moves in the head up direction in the navigation map.

In other words, when a distance to the curve is greater than the target distance before the virtual vehicle is about to enter the curve, the virtual vehicle travels on a straight road. The virtual vehicle keeps the vehicle head direction as the head up direction, so that the virtual vehicle can be efficiently and conveniently guided to travel through left and right directions.

In an embodiment, the navigation method may further include: displaying, on the navigation interface after the virtual vehicle moves out of the curve, that the navigation map and the vehicle head direction of the virtual vehicle start to deviate toward the head up direction until the navigation map and the vehicle head direction of the virtual vehicle are in the head up direction, ending deviation and displaying that the virtual vehicle continues to move in the head up direction on a navigation route of the navigation map.

In other words, after the virtual vehicle moves out of the curve, the vehicle head direction of the virtual vehicle is not directly switched to the head up direction, but gradually and evenly deviates, to cause the vehicle head angle starts to evenly approach and deviate to the original head up direction until the vehicle head angle is exactly the head up direction, then the deviation ends, and the virtual vehicle is kept to continuously move on the navigation route in the head up direction, which can avoid a problem of severe rotation of the map when the virtual vehicle moves out of the curve.

One embodiment of the present disclosure provides a navigation method, performed by a terminal. The method includes the following operations:
obtaining real-time data collected by a sensor arranged on a target vehicle, where the sensor includes at least one of a camera or a radar;
performing positioning calibration on the target vehicle based on the real-time data collected by the sensor to obtain a real-time position of the target vehicle;
displaying a navigation interface configured for navigating the target vehicle, and displaying, on the navigation interface, a navigation map matching the real-time position, where the navigation interface includes a virtual vehicle that moves in the navigation map as the target vehicle travels, and a navigation perspective of the navigation interface is head up;
obtaining route curvature data of a navigation route in the navigation map, where the route curvature data includes a curvature, a curvature radius, and curvature circle center coordinates that correspond to each position point on the navigation route in the navigation map;
determining a curve starting point when it is determined that there is a curve at a preset distance ahead according to the route curvature data;
estimating a trajectory offset after the virtual vehicle moves into the curve according to a current traveling speed of the target vehicle and a curvature radius corresponding to the curve starting point;
estimating a vehicle position after the virtual vehicle moves into the curve according to the trajectory offset;
calculating an estimated deviation angle corresponding to the vehicle position according to the estimated vehicle position and curvature circle center coordinates corresponding to the vehicle position;
determining a deviation angle change amount of a vehicle head angle of the virtual vehicle according to an initial angle when the virtual vehicle moves into the curve and the estimated deviation angle after the virtual vehicle moves into the curve;
calculating a target distance according to the current traveling speed, the initial angle, and the deviation angle change amount;
displaying, on the navigation interface before the virtual vehicle moves into the curve and when a distance between the virtual vehicle and the curve is greater than the target distance, that the virtual vehicle moves in the head up direction in the navigation map;
displaying, on the navigation interface before the virtual vehicle moves into the curve and when the distance between the virtual vehicle and the curve is the target distance, that the navigation map and a vehicle head direction of the virtual vehicle start to evenly deviate from the head up direction in an opposite direction of the curve until the virtual vehicle moves into the curve at the initial angle deviating from the head up direction;
estimating, according to a curvature radius of a curve position point of the vehicle at a current moment and the traveling speed, a trajectory offset of the virtual vehicle at a next moment relative to the current moment after the virtual vehicle moves into the curve at the initial angle deviating from the head up direction and in a process that the virtual vehicle moves into the curve;
estimating a curve position point of the virtual vehicle at the next moment according to the curve position point of the virtual vehicle at the current moment and the trajectory offset;
obtaining curvature circle center coordinates corresponding to the estimated curve position point of the virtual vehicle at the next moment;
determining a deviation angle of the curve position point at the next moment according to the curve position point at the next moment and the curvature circle center coordinates corresponding to the curve position point at the next moment;
displaying, according to a deviation angle α t every moment, that the navigation map and the vehicle head direction of the virtual vehicle dynamically deviate, starting from the initial angle, from the head up direction according to a curving degree of a moved position of the virtual vehicle; and
displaying, in a process that the navigation map and the vehicle head direction of the virtual vehicle dynamically deviate according to the curving degree of the moved position of the virtual vehicle, beyond-line-of-sight content about a front of the curve on the navigation interface.

In this embodiment, starting from the target distance in front of the curve, the vehicle head angle evenly deviates in an opposite direction along with a direction of the curve until the virtual vehicle moves into the curve and is consistent and coherent with the initial angle when the virtual vehicle enters the curve, to cause the navigation map to rotate gradually, which can avoid problems that a driver feels dizzy and an increase in the costs of reading the map resulting from severe rotation of the navigation map caused by a sharp increase in a curvature of the curve when the virtual vehicle enters the curve. When the virtual vehicle moves into a curve on a navigation route as the target vehicle travels, the navigation map and the vehicle head direction of the virtual vehicle no longer keep at the same direction, such as keep head up, but dynamically deviate according to the curving degree of the moved position of the virtual vehicle until the virtual vehicle moves out of the curve. In this way, when the target vehicle travels in the curve, more road environments in the front about the curve are displayed on the navigation interface, increasing prediction and guidance of a driver on a road ahead, thereby improving a navigation effect for the vehicle.

Although the operations are displayed sequentially according to an indication of the arrows in the flowcharts involved in the embodiments, these operations are not necessarily performed sequentially according to a sequence indicated by the arrows. Unless explicitly specified in the present disclosure, an execution sequence of the operations is not strictly limited, and the operations may be performed in other sequences. Moreover, at least some of the operations in the flowcharts involved in the foregoing embodiments may include a plurality of sub-operations or a plurality of stages. The sub-operations or stages are not necessarily performed at the same moment but may be performed at different moments. Execution of the sub-operations or stages is not necessarily sequentially performed, but may be performed alternately or in turn with another operation or at least some of sub-operations or stages of another operation.

Based on the similar concepts, an embodiment of the present disclosure further provides a navigation apparatus configured to implement the foregoing navigation method. An implementation solution to the problem provided by the apparatus is similar to an implementation solution recorded in the foregoing method. Therefore, for specific features in one or more navigation apparatus embodiments provided below, reference may be made to the foregoing navigation method. Details are not described herein again.

In an embodiment, as shown in FIG. 12, a navigation apparatus 1200 is provided, including: a first display module 1202 and a second display module 1204, where
the first display module 1202 is configured to: display a navigation interface, where the navigation interface is configured for navigating a target vehicle; and display, on the navigation interface, a navigation map and a virtual vehicle that moves in the navigation map as the target vehicle travels, where the navigation map includes a curve; and
the second display module 1204 is configured to display, when navigating through the curve, that both the navigation map and a vehicle head direction of the virtual vehicle dynamically deviate according to a curving degree of the curve, where a deviation degree of the dynamic deviation changes along with a change of a curving degree of a moved position of the virtual vehicle in the curve.

In an embodiment, the second display module is further configured to display: that the vehicle head direction of the virtual vehicle dynamically deviates according to the curving degree of the curve; and when the vehicle head direction of the virtual vehicle dynamically deviates according to the curving degree of the curve, that the navigation map correspondingly deviates toward a deviation direction of the vehicle head direction; and the first display module is further configured to display, when the navigation map correspondingly deviates toward the deviation direction of the vehicle head direction, that beyond-line-of-sight content about a front of the curve is moved into the navigation map.

In an embodiment, a navigation perspective of the navigation interface is head up. The second display module is further configured to display that the virtual vehicle moves into the curve from a curve starting point at an initial angle deviating from the head up direction.

In an embodiment, the second display module is further configured to display, after the virtual vehicle moves into the curve from the curve starting point at the initial angle deviating from the head up direction, that the navigation map and the vehicle head direction of the virtual vehicle dynamically deviate from the head up direction according to the curving degree of the moved position of the virtual vehicle until the virtual vehicle moves out of the curve.

In an embodiment, the curve is located on a navigation route of the target vehicle, and the apparatus further includes an initial angle calculation module, configured to: determine a position point at which a curvature on the navigation route of the target vehicle changes from zero to non-zero as the curve starting point of the curve; obtain curvature circle center coordinates corresponding to the curve starting point; and calculate, according to the curve starting point and the curvature circle center coordinates, a deviation angle between a tangent line at the curve starting point and the head up direction as the initial angle when the virtual vehicle moves into the curve.

In an embodiment, the navigation perspective of the navigation interface is the head up, the dynamic deviation is that an angle α t which the vehicle head direction of the virtual vehicle deviates from the head up direction changes along with the change of the curving degree of the moved position of the virtual vehicle in the curve, and the navigation map deviates along with deviation of the vehicle head direction.

In an embodiment, the apparatus further includes a dynamic deviation angle calculation module, configured to: estimate, starting from a moment at which the virtual vehicle moves into the curve, a trajectory offset of the virtual vehicle at a next moment relative to a current moment according to a curvature radius of a moved position and a traveling speed of the virtual vehicle at the current moment; estimate a moved position of the virtual vehicle at the next moment according to the moved position of the virtual vehicle at the current moment and the trajectory offset; obtain curvature circle center coordinates corresponding to the estimated moved position of the virtual vehicle at the next moment; and determine a deviation angle of the moved position at the next moment according to the moved position at the next moment and the curvature circle center coordinates corresponding to the moved position at the next moment.

In an embodiment, the curvature circle center coordinates of the moved position of the virtual vehicle in the curve are a point of the curve on a normal line of the moved position and whose distance from the moved position is the curvature radius, where the curvature radius is a reciprocal of a curvature of the curve at the moved position, and the curvature represents a curving degree of the curve at the moved position.

In an embodiment, the second display module is further configured to display, between a moment at which the virtual vehicle moves to a position at a target distance from entering the curve and a moment at which the virtual vehicle enters the curve, that both the navigation map and the vehicle head direction of the virtual vehicle deviate in an opposite direction of the curve at a plurality of times, where deviation degrees of the plurality of deviation gradually increase in time sequence.

In an embodiment, the apparatus further includes: a target distance calculation module, configured to: determine an initial angle when the virtual vehicle moves into the curve according to a curve starting point of the curve and curvature circle center coordinates corresponding to the curve starting point; and calculate the target distance according to a current traveling speed of the target vehicle and the initial angle.

In an embodiment, the target distance calculation module is further configured to: estimate a trajectory offset after the virtual vehicle moves into the curve according to the current traveling speed of the target vehicle and a curvature radius corresponding to the curve starting point; estimate a vehicle position after the virtual vehicle moves into the curve according to the trajectory offset; calculate an estimated deviation angle corresponding to the vehicle position according to the estimated vehicle position and curvature circle center coordinates corresponding to the vehicle position; determine a deviation angle change amount of a vehicle head angle of the virtual vehicle according to the initial angle when the virtual vehicle moves into the curve and the estimated deviation angle after the virtual vehicle moves into the curve; and calculate the target distance according to the current traveling speed, the initial angle, and the deviation angle change amount.

In an embodiment, the second display module is further configured to display, on the navigation interface before the virtual vehicle moves into the curve and when a distance between the virtual vehicle and the curve is greater than the target distance, that the virtual vehicle moves in the head up direction in the navigation map.

In an embodiment, the second display module is further configured to: display, on the navigation interface after the virtual vehicle moves out of the curve, that the navigation map and the vehicle head direction of the virtual vehicle start to deviate toward the head up direction until the navigation map and the vehicle head direction of the virtual vehicle are in the head up direction, end deviation and display that the virtual vehicle continues to move in the head up direction on a navigation route of the navigation map.

In an embodiment, the apparatus further includes an obtaining module, configured to: obtain a real-time position of the target vehicle; display, on the navigation interface, a navigation map matching the real-time position; and obtain route curvature data of a navigation route in the navigation map, where the route curvature data includes a curvature, a curvature radius, and curvature circle center coordinates that correspond to each position point on the navigation route in the navigation map.

In an embodiment, the obtaining module is further configured to: obtain real-time data collected by a sensor arranged on the target vehicle, where the sensor includes at least one of a camera or a radar; and perform positioning calibration on the target vehicle based on the real-time data collected by the sensor to obtain the real-time position of the target vehicle.

In an embodiment, the obtaining module is configured to: obtain a preset distance; and obtain, based on the real-time position of the target vehicle, route curvature data located at the preset distance ahead of the real-time position on the navigation route in the navigation map.

The navigation apparatus 1200 displays, in a process of navigating a target vehicle, a navigation interface configured for navigating the target vehicle, where the navigation interface includes a virtual vehicle that represents the target vehicle and moves as the target vehicle travels on a road. When the virtual vehicle moves into a curve on a navigation route as the target vehicle travels, a navigation map and a vehicle head direction of the virtual vehicle no longer keep at the same direction, such as keep head up, but dynamically deviate according to a curving degree of the moved position of the virtual vehicle until the virtual vehicle moves out of the curve. In this way, when the target vehicle travels in the curve, more road environments in the front about the curve are displayed on the navigation interface, increasing prediction and guidance of a driver on a road ahead, thereby improving a navigation effect for the vehicle.

Each module of the navigation apparatus 1200 may be implemented entirely or partially through software, hardware, or a combination thereof. The foregoing modules may be built in or independent of a processor of a computer device in a form of hardware, or may be stored in a memory of the computer device in a form of software, so that the processor invokes and executes operations corresponding to the foregoing modules.

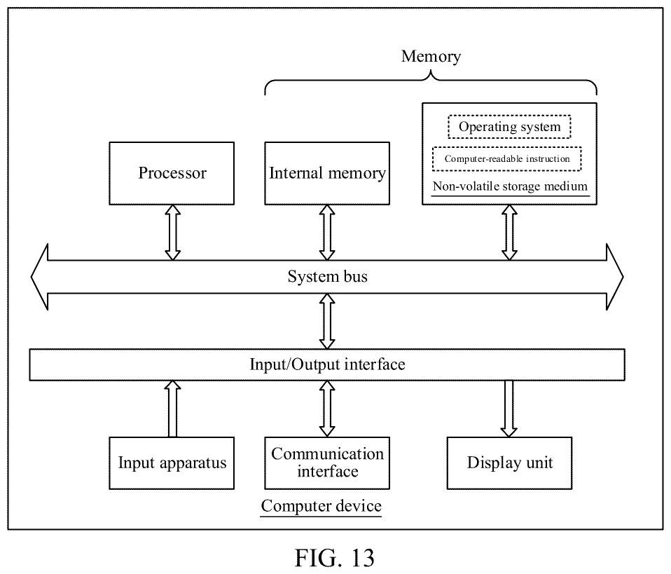

In an embodiment, a computer device is provided, where the computer device may be a terminal, and an internal structure thereof may be shown as FIG. 13. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide calculation and control ability. The memory of the computer device includes a non-volatile storage medium and an internal memory. The non-volatile storage medium stores an operating system and a computer-readable instruction. The internal memory provides an environment for running the operating system and the computer-readable instruction in the non-volatile storage medium. The input/output interface of the computer device is configured to exchange information between the processor and an external device. The communication interface of the computer device is configured to communicate with an external terminal in a wired or wireless manner, where the wireless manner may be implemented through Wi-Fi, a mobile cellular network, near field communication (NFC), or another technology. The computer-readable instruction is executed by the processor to implement a navigation method. The display unit of the computer device is configured to form a visually visible picture, which may be a display screen, a projection apparatus, or a virtual reality imaging apparatus. The display screen may be a liquid crystal display screen or an e-ink display screen. The input apparatus of the computer device may be a touch layer covering on the display screen, or may be a button, a trackball, or a touchpad arranged on a housing of the computer device, or may be an external keyboard, touchpad, a mouse, or the like.

A person skilled in the art may understand that, the structure shown in FIG. 13 is merely a block diagram of a partial structure related to a solution in the present disclosure, and does not constitute a limitation to the computer device to which the solution in the present disclosure is applied. Specifically, the computer device may include more components or fewer components than those shown in the figure, or some components may be combined, or a different component deployment may be used.

In an embodiment, a computer device is provided, including a memory and a processor, where the memory stores computer-readable instructions, and when executing the computer-readable instructions, the processor performs the navigation method according to any one or more embodiments of the present disclosure.

In an embodiment, a computer-readable storage medium is provided, having computer-readable instructions stored therein, when the computer-readable instructions are executed by a processor, the navigation method according to any one or more embodiments of the present disclosure is performed.

In an embodiment, a computer program product is provided, including computer-readable instructions, when the computer-readable instructions are executed by a processor, the navigation method according to any one or more embodiments of the present disclosure is performed.

User information (including but not limited to user equipment information, user personal information, and the like) and data (including but not limited to data for analysis, stored data, displayed data, and the like) involved in the present disclosure are all information and data authorized by users or fully authorized by all parties, and collection, use, and processing of relevant data need to comply with relevant laws, regulations, and standards of relevant countries and regions.

A person of ordinary skill in the art may understand that some or all procedures in the method in the foregoing embodiments may be implemented by a computer-readable instruction instructing related hardware, where the computer-readable instruction may be stored in a non-volatile computer-readable storage medium, and when the computer-readable instruction is executed, the procedures in the foregoing method embodiments may be implemented. Any reference to a memory, a database, or another medium used in the various embodiments provided in the present disclosure may include at least one of a non-volatile or volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM), an external cache memory, or the like. As an illustration rather than a limitation, the RAM is available in various forms, such as a static random access memory (DRAM) or a dynamic random access memory (SRAM). The database involved in the embodiments provided in the present disclosure may include at least one of a relational database or a non-relational database. The non-relational database may include a block chain-based distributed database, or the like. This is not limited therein. The processor involved in the embodiments of the present disclosure may be a general-purpose processor, a central processing unit, a graphics processing unit, a digital signal processor, a programmable logic device, a quantum computing-based data processing logic device, or the like. This is not limited therein.

Technical features of the foregoing embodiments may be combined in different manners to form other embodiments. For concise description, not all possible combinations of the technical features in the embodiment are described. However, the combinations of the technical features shall all be considered as falling within the scope described in this specification provided that they do not conflict with each other.

The foregoing embodiments only describe several implementations of the present disclosure, and are described in detail, but they are not to be construed as a limitation to the patent scope of the present disclosure. A person of ordinary skill in the art may further make variations and improvements without departing from the ideas of the present disclosure, which shall fall within the protection scope of the present disclosure. Therefore, the protection scope of the present disclosure is subject to the appended claims.

What is claimed is:

1. A navigation method, performed by a computer device, the method comprising:
displaying a navigation interface for navigating a target vehicle;
displaying, on the navigation interface, a navigation map and a virtual vehicle that moves in the navigation map as the target vehicle travels, the navigation map comprising a curve; and
displaying, when navigating through the curve, that both the navigation map and a vehicle head direction of the virtual vehicle dynamically deviate according to a curving degree of the curve, a deviation degree of the dynamic deviation changing along with a change of a curving degree of a moved position of the virtual vehicle in the curve.

2. The method according to claim 1, wherein that both the navigation map and a vehicle head direction of the virtual vehicle dynamically deviate according to a curving degree of the curve comprises:
dynamically deviating the vehicle head direction of the virtual vehicle according to the curving degree of the curve; and
when the vehicle head direction of the virtual vehicle dynamically deviates according to the curving degree of the curve, deviating the navigation map correspondingly toward a deviation direction of the vehicle head direction; and
the method further comprises:
when the navigation map deviates correspondingly toward the deviation direction of the vehicle head direction, moving beyond-line-of-sight content about a front of the curve into the navigation map.

3. The method according to claim 1, wherein a navigation perspective of the navigation interface is head up; and the method further comprises:
displaying that the vehicle head direction of the virtual vehicle moves into the curve from a curve starting point at an initial angle deviating from the head up direction.

4. The method according to claim 3, wherein the displaying, when navigating through the curve, that both the navigation map and a vehicle head direction of the virtual vehicle dynamically deviate according to a curving degree of the curve comprises:
displaying, after the virtual vehicle moves into the curve from the curve starting point at the initial angle deviating from the head up direction, that the navigation map and the vehicle head direction of the virtual vehicle dynamically deviate from the head up direction according to the curving degree of the moved position of the virtual vehicle until the virtual vehicle moves out of the curve.

5. The method according to claim 3, wherein the curve is located on a navigation route of the target vehicle, and the method further comprises:
determining a position point at which a curvature on the navigation route of the target vehicle changes from zero to non-zero as the curve starting point of the curve;
obtaining coordinates of a center of the curvature corresponding to the curve starting point; and
calculating, according to the curve starting point and the coordinates of the center of the curvature, a deviation angle between a tangent line at the curve starting point and the head up direction as the initial angle when the virtual vehicle moves into the curve.

6. The method according to claim 1, wherein the navigation perspective of the navigation interface is the head up, the dynamic deviation is that an angle α t which the vehicle head direction of the virtual vehicle deviates from the head up direction changes along with the change of the curving degree of the moved position of the virtual vehicle in the curve, and the navigation map deviates along with deviation of the vehicle head direction.

7. The method according to claim 6, further comprising:
estimating, starting from a moment at which the virtual vehicle moves into the curve, a trajectory offset of the virtual vehicle at a next moment relative to a current moment according to a curvature radius of a moved position and a traveling speed of the virtual vehicle at the current moment;
estimating a moved position of the virtual vehicle at the next moment according to the moved position of the virtual vehicle at the current moment and the trajectory offset;
obtaining curvature circle center coordinates corresponding to the estimated moved position of the virtual vehicle at the next moment; and
determining a deviation angle of the moved position at the next moment according to the moved position at the next moment and the curvature circle center coordinates corresponding to the moved position at the next moment.

8. The method according to claim 7, wherein the curvature circle center coordinates of the moved position of the virtual vehicle in the curve are coordinates of a point of the curve on a normal line of the moved position and whose distance from the moved position is the curvature radius, wherein the curvature radius is a reciprocal of a curvature of the curve at the moved position, and the curvature represents a curving degree of the curve at the moved position.

9. The method according to claim 1, further comprising:
displaying, in a process in which the virtual vehicle moves from a position at a target distance from the curve into the curve, that both the navigation map and the vehicle head direction of the virtual vehicle gradually deviate in a direction opposite to a curving direction of the curve.

10. The method according to claim 9, further comprising:
determining an initial angle when the virtual vehicle moves into the curve according to a curve starting point of the curve and curvature circle center coordinates corresponding to the curve starting point; and
calculating the target distance according to a current traveling speed of the target vehicle and the initial angle.

11. The method according to claim 10, wherein the calculating the target distance according to a current traveling speed of the target vehicle and the initial angle comprises:
estimating a trajectory offset after the virtual vehicle moves into the curve according to the current traveling speed of the target vehicle and a curvature radius corresponding to the curve starting point;
estimating a vehicle position after the virtual vehicle moves into the curve according to the trajectory offset;
calculating an estimated deviation angle corresponding to the vehicle position according to the estimated vehicle position and curvature circle center coordinates corresponding to the vehicle position;
determining a deviation angle change amount of a vehicle head angle of the virtual vehicle according to the initial angle when the virtual vehicle moves into the curve and the estimated deviation angle after the virtual vehicle moves into the curve; and
calculating the target distance according to the current traveling speed, the initial angle, and the deviation angle change amount.

12. The method according to claim 1, further comprising:
displaying, on the navigation interface before the virtual vehicle moves into the curve and when a distance between the virtual vehicle and the curve is greater than the target distance, that the virtual vehicle moves in the head up direction in the navigation map.

13. The method according to claim 1, further comprising:
displaying, on the navigation interface after the virtual vehicle moves out of the curve, that the navigation map and the vehicle head direction of the virtual vehicle start to deviate toward the head up direction until the navigation map and the vehicle head direction of the virtual vehicle are in the head up direction, ending the dynamic deviation and displaying that the virtual vehicle continues to move in the head up direction on a navigation route of the navigation map.

14. The method according to any one of claims 1 to 13, further comprising:
obtaining a real-time position of the target vehicle;
displaying, on the navigation interface, a navigation map matching the real-time position; and
obtaining route curvature data of a navigation route in the navigation map, wherein the route curvature data comprises a curvature, a curvature radius, and curvature circle center coordinates that correspond to each position point on the navigation route in the navigation map.

15. The method according to claim 14, wherein the obtaining a real-time position of the target vehicle comprises:
obtaining real-time data collected by a sensor arranged on the target vehicle, wherein the sensor comprises at least one of a camera or a radar; and
performing positioning calibration on the target vehicle based on the real-time data collected by the sensor to obtain the real-time position of the target vehicle.

16. The method according to claim 14, wherein the obtaining route curvature data of a navigation route in the navigation map comprises:
obtaining a preset distance; and
obtaining, based on the real-time position of the target vehicle, route curvature data located at the preset distance ahead of the real-time position on the navigation route in the navigation map.

17. A navigation apparatus, comprising:
a memory and at least one processor, the memory storing computer-readable instructions, and when executing the computer-readable instructions, the at least one processor being configured to perform:
displaying a navigation interface for navigating a target vehicle;
displaying, on the navigation interface, a navigation map and a virtual vehicle that moves in the navigation map as the target vehicle travels, the navigation map comprising a curve; and
displaying, when navigating through the curve, that both the navigation map and a vehicle head direction of the virtual vehicle dynamically deviate according to a curving degree of the curve, a deviation degree of the dynamic deviation changing along with a change of a curving degree of a moved position of the virtual vehicle in the curve.

18. The apparatus according to claim 17, wherein that both the navigation map and a vehicle head direction of the virtual vehicle dynamically deviate according to a curving degree of the curve comprises:
dynamically deviating the vehicle head direction of the virtual vehicle according to the curving degree of the curve; and
when the vehicle head direction of the virtual vehicle dynamically deviates according to the curving degree of the curve, deviating the navigation map correspondingly toward a deviation direction of the vehicle head direction; and
the at least one processor is further configured to perform:
when the navigation map deviates correspondingly toward the deviation direction of the vehicle head direction, moving beyond-line-of-sight content about a front of the curve into the navigation map.

19. The apparatus according to claim 17, wherein a navigation perspective of the navigation interface is head up; and the at least one processor is further configured to perform:
displaying that the vehicle head direction of the virtual vehicle moves into the curve from a curve starting point at an initial angle deviating from the head up direction.

20. A non-transitory computer-readable storage medium, having computer-readable instructions stored therein, when being executed by at least one processor, the computer-readable instructions causing the at least one processor to perform:
displaying a navigation interface for navigating a target vehicle;
displaying, on the navigation interface, a navigation map and a virtual vehicle that moves in the navigation map as the target vehicle travels, the navigation map comprising a curve; and
displaying, when navigating through the curve, that both the navigation map and a vehicle head direction of the virtual vehicle dynamically deviate according to a curving degree of the curve, a deviation degree of the dynamic deviation changing along with a change of a curving degree of a moved position of the virtual vehicle in the curve.
